(19) United States
(12) Patent Application Publication
(10) Pub. No.: US 2019/0202145 A1
(43) Pub. Date: Jul. 4, 2019

(54) IMPROVEMENTS IN OR RELATING TO INFUSION MOULDING

(71) Applicant: HEXCEL COMPOSITES LIMITED, Duxford, Cambridgeshire (GB)

(72) Inventors: Steve MORTIMER, Cambridgeshire (GB); Neal PATEL, Cambridge (GB); Scott STEVENS, Cambridge (GB)

(73) Assignee: HEXCEL COMPOSITES LIMITED, Duxford, Cambridgeshire (GB)

(21) Appl. No.: 16/314,212

(22) PCT Filed: Jul. 6, 2017
(86) PCT No.: PCT/EP2017/067045

§ 371 Date: Dec. 28, 2018

(30) Foreign Application Priority Data
Jul. 7, 2016 (GB) 1611866.3

(51) Int. Cl. B29C 70/48; B29C 31/06; B29C 31/10; B29B 7/72; B29B 7/76; B29B 7/74; C08G 59/50

(52) U.S. Cl. CPC B29C 70/48; B29C 31/06; B29C 31/10; G05D 11/136; B29B 7/7615; B29B 7/7471; C08G 59/50; B29B 7/726

(57) ABSTRACT

The invention relates to a resin infusion process wherein a curable flowing fluid resin composition is supplied to form a curable matrix around a fibrous reinforcement material, wherein the curable flowing fluid resin composition comprises a resin component (1) and an activator component (2), and at least one property of the curable flowing fluid resin composition is monitored prior to supply.

The present invention relates to improvements in or relating to an infusion process for the production of fibre reinforced composites. The infusion process which is also often referred to as a resin transfer moulding (RTM) process is a process in which dry fibrous material is laid up in a mould and a liquid curable resin is infused or transferred into the mould to impregnate the fibrous material with a resin composition which is subsequently allowed to cure. Often the dry fibrous material is located inside a vacuum enclosure, such as a mould to which a vacuum may be applied, which aids the infusion as the reduced pressure draws the resin into the fibrous material. This process is referred to as vacuum assisted resin transfer moulding (VARTM).

Such a process is described in U.S. Pat. No. 8,356,989 and is used to produce a wide variety of lightweight high strength components—typically relatively large components such as aerospace and automobile components, wind turbine components such as blades and spars and sporting goods such as skis. The fibrous materials may be woven or non-woven and typically are of glass fibre, carbon fibre or aramid fibre.

The curable resin composition should be such that on supply to the mould it will flow sufficiently to easily surround and/or infuse the fibrous material to form a continuous matrix and yet be in a curable state. The resin compositions used are typically liquid polyester or epoxy resin components, containing an activator, also known as a curative, that can activate cross linking of the epoxy resin components to form a solid resin matrix which contains the fibrous reinforcement material in the composite part. In this case, an activator means any component capable of causing at least one component of the resin composition to cross link, or promoting cross linking in the composition. Such activators include curatives that are known to cure thermosetting resins, such as epoxy resins. The curing reaction is accelerated by heat, which may be applied externally and/or may be generated by the heat of reaction of the resin composition. Activators which are radiation sensitive may also be used to enhance the rate of curing reaction.

Conventionally resin compositions containing resin components and activators in the form of one or more curatives, optionally in combination with accelerator components, are provided to the customer as a single material for use in infusion processes. This, however, suffers from the disadvantage that premature curing of the resin may occur during transport and storage of the mixture prior to use, particularly if the curing reaction has not been sufficiently arrested by managing the temperature of the resin compositions. In any case, in these premixed resin compositions, the user does not know how far reaction has progressed following transport and storage as a result of exposure to varying temperatures, particularly so when the material was perhaps stored in warehouses or workshops which do not provide a temperature controlled environment. Furthermore, the user of the premixed resin compositions does not have any flexibility to vary the ratio of resin to activator according to the moulding conditions to be employed and the component to be manufactured.

In some cases therefore, the resin and the activator may be supplied separately for mixing shortly before supply to the mould. However, care must be taken to ensure that the state of the mixture is appropriate for the infusion and moulding operation in which it will be used.

The present invention aims to obviate or at least mitigate the above described problems and/or to provide improvements generally.

According to the invention there is provided a process according to any one of the accompanying claims.

In an embodiment, the invention provides a resin infusion process wherein a flowing curable fluid resin composition is supplied to form a curable matrix around a fibrous reinforcement material, wherein the curable fluid resin composition comprises a resin component and an activator component (or “curative” component), and at least one property of the resin composition is monitored prior to supply.

The process preferably involves a feedback loop from the monitoring device which can adjust the composition of the curable flowing fluid resin composition if undesirable deviations are detected, or can halt the process if necessary.

More preferably the process involves a feedback loop from a monitoring device to adjust the composition of the curable flowing fluid resin composition if undesirable deviations are detected, or to halt the process if necessary. The monitoring device may be adapted to control the composition of the curable flowing fluid resin composition.

Particularly preferred resin infusion processes of the present invention are processes in which a reduced pressure is used to facilitate resin flow around the fibrous reinforcement material.

In preferred embodiments of the present invention the resin component and the activator component are mixed in-line. The mixing may be a batch process or a continuous process.

The curable flowing fluid resin composition may be a liquid, a semi-solid, a powder or a gas. The invention is particularly useful when the curable flowing fluid resin composition and/or the resin component is a liquid.

The property of the flowing stream of curable fluid resin composition mixture that is to be measured can be varied according to the nature of the resin component and the activator component, and also according to the nature of the part that is to be moulded. However, the viscosity and the flow properties of the composition are important, and they can be monitored using a rheometer to monitor viscosity. Another important factor is the extent to which the resin composition may have pre-reacted and cured which may be accelerated due to contact with the activator. As resins cure their T_{g} changes (usually increases), and so it may be useful to monitor the T_{g} of the mixture as it is being supplied to the mould. However it is not possible to monitor the T_{g} directly online. So parameters are monitored which are relevant to formulation of the resin composition which impacts the T_{g} of the cured resin composition matrix. Relevant parameters may include the refractive index, viscosity for a given temperature, ratio of epoxy concentration in relation to amine concentration or stoichiometry in the composition, colour, and/or concentration of contaminants. Parameters may be monitored by use of a spectrometer, such as an in-line spectrometer, a colour sensor, such as a colorimeter, a viscometer, a conductivity sensor, a capacitance sensor, a radiation sensor, a thermometer, a flow meter or a combination of one or more of these instruments.

Another important factor is to ensure that the resin and the curing agent are properly mixed to form a homogeneous mixture, as this is required to ensure uniform properties of the final moulding. Accordingly it may be useful to monitor the composition of the resin feed as it is supplied to the mould. This could be accomplished by colouring each of the materials so that a certain colour will be formed on blending and monitoring the colour of the feed stream to the mould (using a colorimeter).

In the production of fibre reinforced materials from curable resins it is desirable that the resin uniformly impregnates the fibrous material for which a low viscosity is required and yet when the resin is cured it can be desirable that it has a high Tg. Although the resins employed are thermocurable their viscosity can be reduced by heating to a temperature below their final cure. However, the resins also have a cure cycle whereby they are cured by being subjected to a certain temperature or range of temperatures for a specified period of time to ensure that the final cured resin matrix has the desired T_{g}. However precure or advancement of the resin composition before supply to the mould should be avoided and the occurrence can be determined by differential scanning calorimeter (DSC) testing so that, if necessary, remedial action can be taken. DSC measurements are, however, time-consuming and they cannot be conducted on-line. The present invention aims to obviate this problem by measuring parameters of the resin composition which directly impact its formulation and therefore its T_{g}.

The resin component used in this invention may be any curable resin. Examples of suitable resins are epoxy resins, polyester resins and bismaleimide resins. Liquid resins are preferred. Preferred resins are epoxy resins. The curable flowing fluid resin compositions contain an activator, or curative, which enables the cure process, and the activator is frequently used together with an accelerator. Dicyandiamide is a typical activator, which may be used together with a urea based accelerator. The relative amount of the activator and the epoxy resin that should be used will depend upon the reactivity of the resin and the nature and quantity of the fibrous reinforcement.

The required viscosity of the resin composition and the conditions employed for impregnation of the fibrous material by the resin composition are selected to enable the flow of the resin within the mould to give the desired degree of impregnation of the fibrous material. It is preferred that the resin has a viscosity (ASTM D2196) of from 10 cP to 100 cP at 120° C. and from 100 cP to 1000 cP at 60° C. It is preferred that the resin content is such that, after curing, the structure contains from 30 to 50 wt %, preferably 31 to 48 wt % more preferably 32 to 45 wt % of the resin.

The resin components used in this invention are preferably epoxy resins, and they preferably have an Epoxy Equivalent Weight (EEW) in the range from 100 or 150 to 1500, preferably from 100 or 200 to 500, and the curable flowing fluid resin compositions comprises the resin component and an activator component, such as an accelerator or curing agent. Suitable epoxy resins may comprise blends of two or more epoxy resins selected from monofunctional, difunctional, trifunctional and/or tetrafunctional epoxy resins.

The curable flowing fluid resin compositions used in the present invention preferably contain epoxy resin components and one or more amine based activator components, preferably one or more bisaniline based activators, such as methylene bisaniline based activators, preferably at concentrations ranging from 0.5 to 50 wt % based on the total weight of the resin composition, more preferably from 20 to 40 wt %. In a particularly preferred embodiment the ratio of amine to epoxy groups in the curable flowing fluid resin composition is monitored.

The fibrous reinforcement material employed in this invention may be any reinforcement fibre, such as glass fibre, carbon fibre or aramid fibre and may be woven or non-woven. Tows of material may be preferred. Where tows are employed, they may be made up of a plurality of individual filaments. There may be many thousands of individual filaments in a single tow. The tows, and the filaments within the tows, are generally unidirectional with the individual filaments aligned substantially parallel. Typically, the number of filaments in a tow can range from 1,000 to 50,000 or greater, such as 1,000, 3,000, 6,000, 12,000 or 48,000.

The fibrous reinforcement material to which this invention may be applied may be multifilament tows, which may comprise cracked (i.e. stretch-broken), selectively discontinuous or continuous filaments. The filaments may be made from a wide variety of materials, such as carbon, basaltic fibre, graphite, glass, metalized polymers, aramid and mixtures thereof. Glass and carbon fibres tows are preferred carbon fibre tows, being preferred for aerospace components hulls of boats and and wind turbine shells of length above 40 metres such as from 50 to 60 metres. The structural fibres are individual tows made up of a multiplicity of unidirectional individual fibres.

Preferred fibres are carbon and glass fibres. Hybrid or mixed fibre systems may also be envisaged. The use of cracked (i.e. stretch-broken) or selectively discontinuous fibres may be advantageous to facilitate lay-up of the product according to the invention and improve its capability of being shaped. Although a unidirectional fibre alignment is preferable, other forms may also be used. Typical textile forms include simple textile fabrics, knit fabrics, twill fabrics and satin weaves. It is also possible to envisage using non-woven or non-crimped fibre layers. The surface mass of fibres within the fibrous reinforcement is generally 80-4000 g/m², preferably 10-250 g/m², and especially preferably 150-200 g/m². The number of carbon filaments per tow can vary from 1,000 to 50,000, again preferably from 1,000 to 48,000, and most preferably from 3,000 to 24,000. For fibreglass reinforcements, fibres of 600-2400 tex are particularly adapted.

Exemplary layers of unidirectional fibrous tows are made from HexTow® carbon fibres, which are available from Hexcel Corporation. Suitable HexTow® carbon fibres for use in making unidirectional fibre tows include: IM7 carbon fibres, which are available as tows that contain 6,000 or 12,000 filaments and weight 0.223 g/m and 0.446 g/m respectively; IM8-IM10 carbon fibres, which are available as tows that contain 12,000 filaments and weigh from 0.446 g/m to 0.324 g/m; and AS7 carbon fibres, which are available in tows that contain 12,000 filaments and weigh 0.800 g/m.

Epoxy resins can become brittle upon curing, and toughening materials can be included with the resin to impart durability. For resins for use in infusion processes, core-shell particles, particularly core-shell rubbers, are particularly suitable toughening components.

The method employed for the monitoring of the property of the resin composition according to this invention may be any suitable method chosen according to the property to be monitored. For example a viscometer may be used to monitor the viscosity of the material. Spectrometric analysis such as infra-red analysis may be used to monitor the chemical composition of the resin composition. Where an epoxy resin component is employed with an amine activator component the composition of the resin composition can be monitored by infra-red spectroscopy. The composition can be monitored for example for amine content against a previously established required amine content and the system may be provided with a feedback loop which can adjust the amine content to the required level if any deviations therefrom are detected.

In a preferred embodiment of the present invention, at least one property of the curable flowing fluid resin composition is monitored at regular time intervals.

In a preferred embodiment of the present invention, at least one property of the curable flowing fluid resin composition is monitored indirectly prior to supply.

In a particularly preferred embodiment of the present invention the property that is monitored is the chemical composition or the stoichiometry of the curable flowing fluid resin composition, such as the relative proportions of resin component and activator component. This embodiment is particularly advantageous when an epoxy resin is used as the resin component and an amine curative is used as the activator component, as the ratio of amine to epoxy groups can be measured in the curable flowing fluid resin composition following mixing and before the mixture is supplied to a fibrous reinforcement material to ensure that the composition is suitable for use before application.

In embodiments of the present invention in which the chemical composition or stoichiometry of the curable flowing fluid resin composition is monitored the monitoring is preferably carried out by use of a spectrometer, preferably a near infrared spectrometer. Preferred spectrometers comprise a probe for taking readings and an analyser for analysing the readings collected by the probe. Particularly suitable spectrometers include Fourier transform infrared (FTIR) and Fourier transform near-infrared FT-NIR spectrometers. Examples of suitable spectrometers include the TALYS ASP500 series of spectrometers, available from ABB, such as the single channel process analyser TALYS ASP501, equipped with one or more suitable probes.

In embodiments of the present invention in which the chemical composition or stoichiometry of the curable flowing fluid resin composition is monitored by use of a spectrometer the monitoring is preferably carried out as the curable flowing fluid resin composition passes through a measurement component. The measurement component is a region in which spectroscopic measurement of the curable flowing fluid resin composition may be carried out, and may comprise a part of the apparatus in which the resin and activator components are mixed or a separate component. An example of a separate component is a component through which the curable flowing fluid resin composition is passed after mixing, such as a conduit (for example, a tube or pipe) forming part of a feed-back loop, or a conduit through which the mixed curable flowing fluid resin composition is supplied to a fibrous reinforcement material.

In such embodiments the spectrometer is preferably located outside the measurement component so that the curable flowing fluid resin composition does not contact any part of the spectrometer. By locating the spectrometer outside the measurement component contact between the curable flowing fluid resin composition and any parts of the spectrometer can be prevented, thereby avoiding possible damage of the spectrometer, particularly the measurement probe, and/or contamination of the curable flowing fluid resin composition by materials present on the contacted parts of the spectrometer. Suitably, the curable flowing fluid resin composition can be passed through a component in which a spectrometer probe is maintained in position to monitor the composition without coming into contact with the composition, such as a Clippir accessory available from ABB (for example, an ACC127-Clippir wet process analyser accessory).

Preferably the walls of the measurement component do not absorb in the regions used for spectroscopic monitoring. This helps to reduce or prevent interference in the spectroscopic monitoring caused by interactions with the walls of the measurement component.

Suitably the measurement component is at least partially formed from silicone, a perfluoroalkoxy material or glass, such as high quality optical glass.

Preferably the internal diameter of the measurement component is selected to not interfere with the spectroscopic monitoring. This helps to reduce or prevent interference in the spectroscopic monitoring caused by interactions with the walls of the measurement component. Thus, the internal diameter of the measurement component can be key to model construction, such that there is a preferential range of internal diameters associated with each material that may be tested. Specifically, as shown by Beer's Law, Absorbance is equal to molar coefficient (e) times path length (l) times the concentration of the solution (c); so if (e) and (c) are constant but the path length changes then the absorbance will be altered. So if the tubing is changed the path length (internal diameter) needs to be maintained.

The invention is illustrated but in no way limited to the accompanying drawings in which.

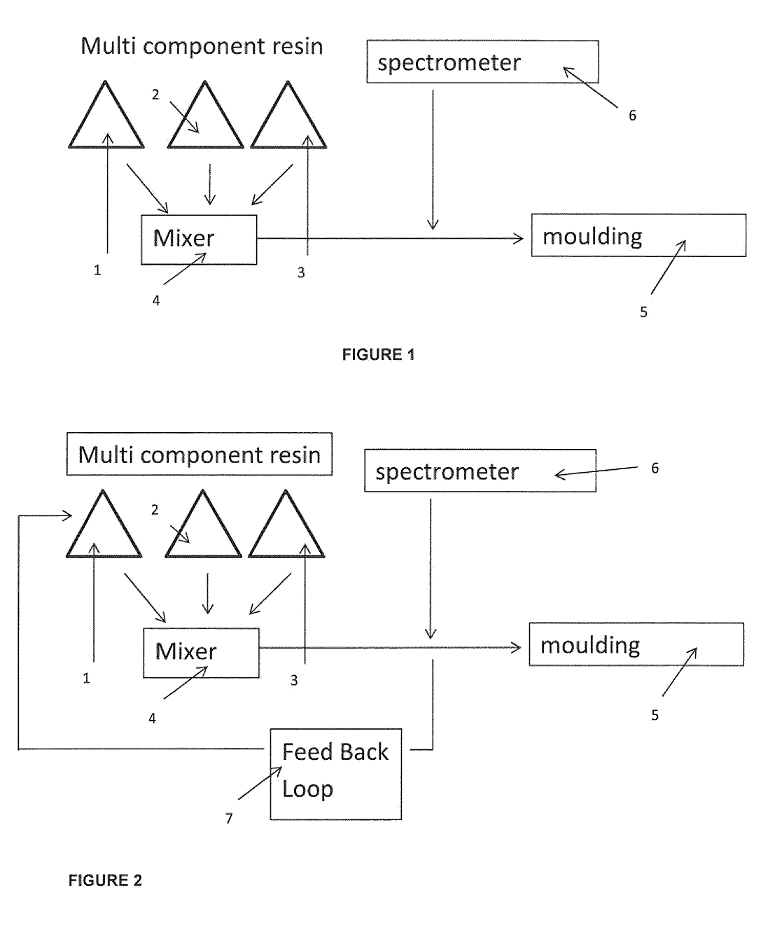

FIG. 1 is a schematic illustration of the process of this invention;

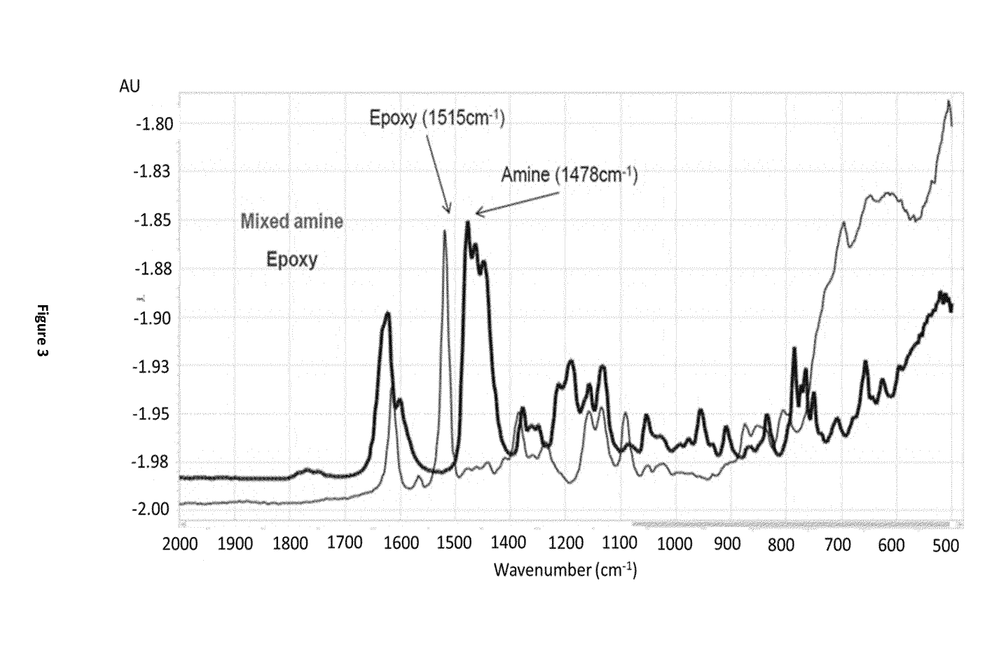

FIG. 2 is the schematic illustration according to FIG. 1 including a feedback loop for the adjustment of the resin composition;

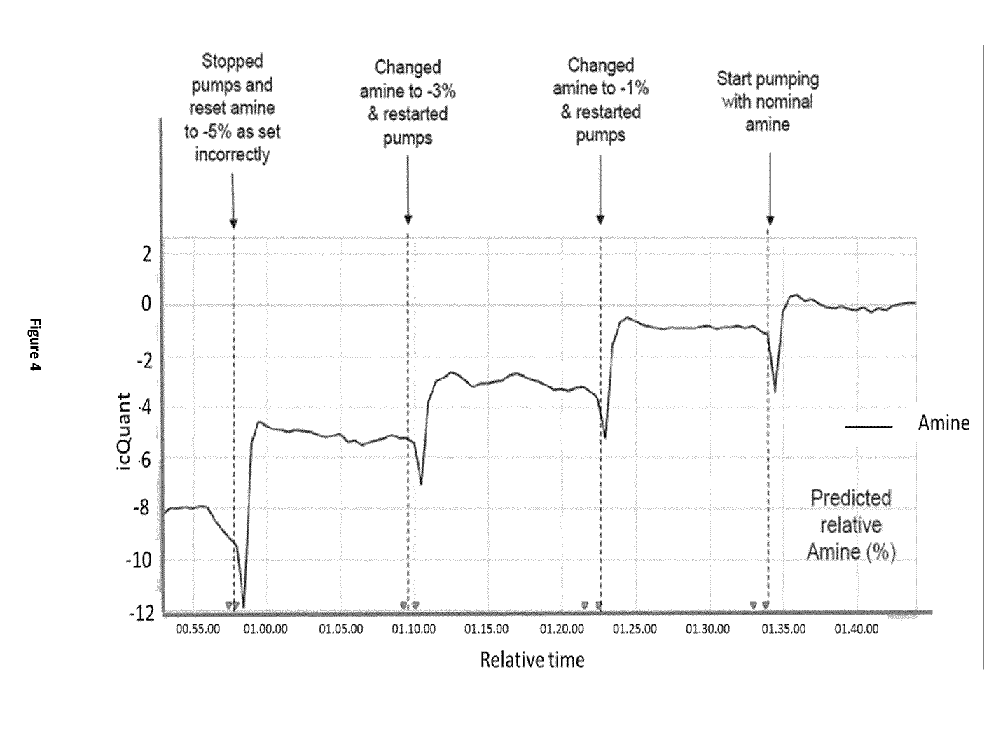

FIG. 3 is an infrared plot according to Example 1;

FIG. 4 is a diagram showing the ratio of epoxy groups in relation to amine groups in a resin composition over time;

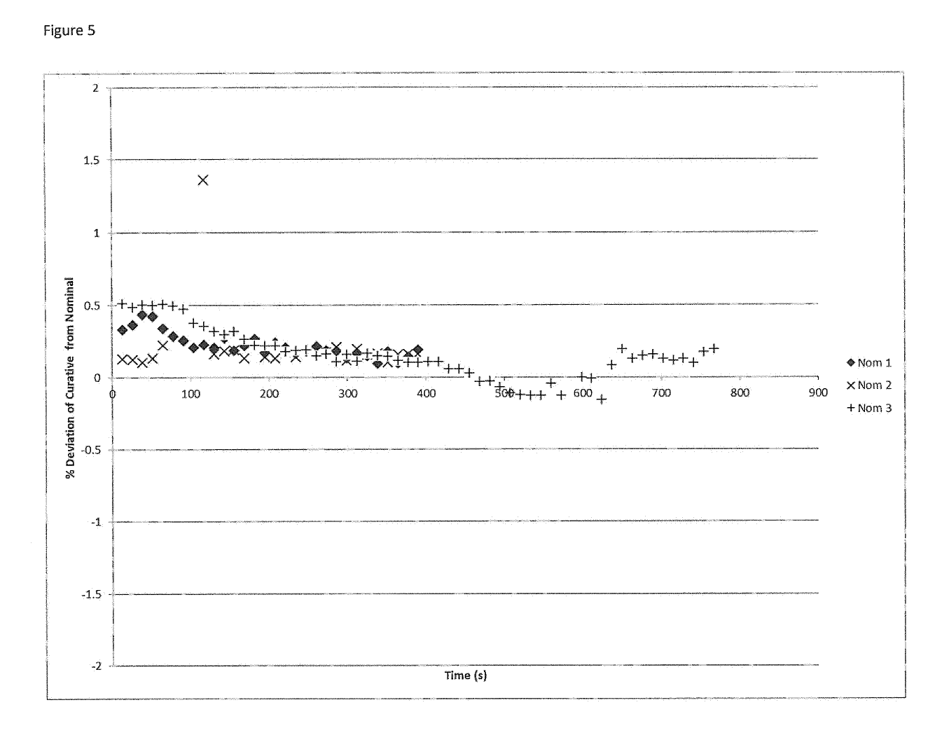

FIG. 5 is a diagram showing the percentage curative measured in a standard batch of curable resin over three test runs in accordance with Example 2; and

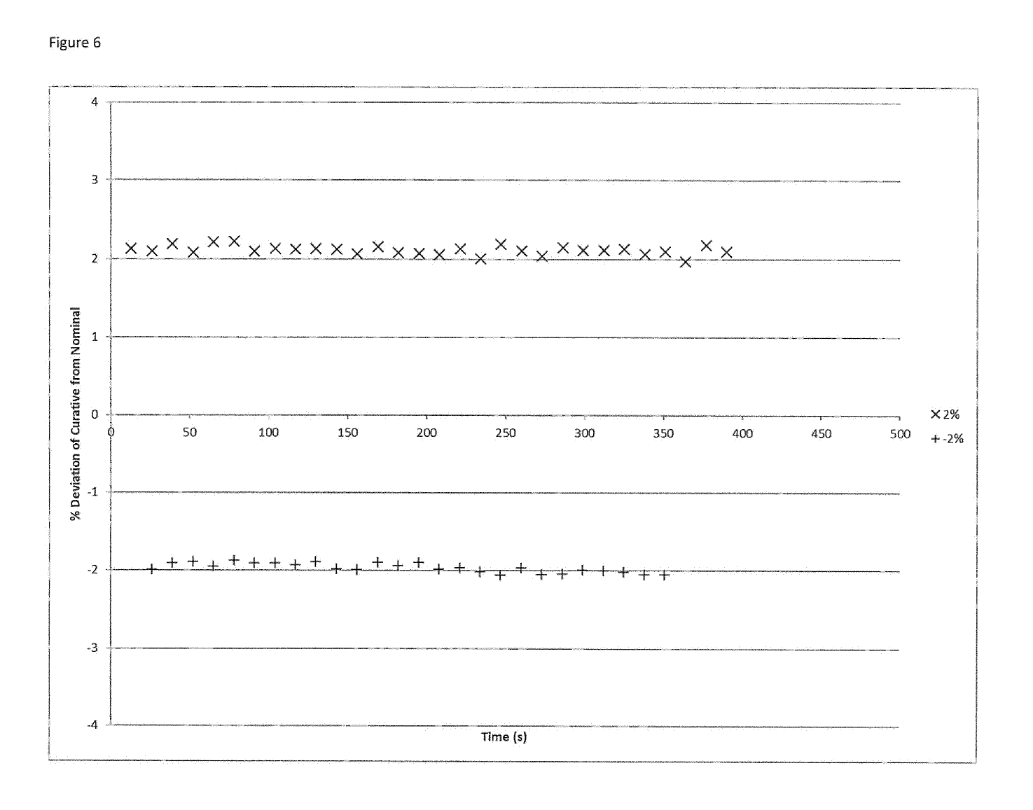

FIG. 6 is a diagram showing the percentage curative measured in two non-standard batches of curable resin in accordance with Example 3.

FIG. 1 shows three sources of components (1, 2 and 3) comprising a resin (1) an activator (2) and an accelerator (3) for the activator. The components are fed to a mixer (4) where they are mixed and pumped to a mould (5). A spectrometer (6) is provided to monitor the composition of the fluid resin being supplied to the mould.

In FIG. 2 the same numerals indicate the same components as in FIG. 1, with the addition of a feedback loop (7), which can adjust the feed of the components (1, 2 and 3) as required as indicated by the monitoring by the spectrometer.

The invention is further illustrated by the following Examples.

### EXAMPLE 1

A fibre optic probe is introduced between the outlet of a two-component resin component mixing machine and the inlet of a mould as shown in FIG. 1. The machine is adapted to produce an infusion resin composition from multiple components. The mould may be for the production of an aerospace component.

The mixing machine was an Isojet two-component mixing machine and was used to mix a resin composition comprising component A, which is a mixture of epoxy resins and component B, which is a mixture of amine based activator components also commonly referred to as curatives.

The probe transfers a signal to an infra-red analyser that produces spectra that can be interpreted in real-time to give a measure of the composition of the resin mixture such as the amine to epoxy concentration ratio. The spectra may also be analysed to check for impurities or other chemical species.

The output of the infra-red analyser could be set as an alarm or to stop the mixing or injection processes if the mixture is not within predefined tolerances.

The mixing machine consists of two heated tanks for storing Part A and Part B components. An arrangement of gear pumps and flow meters feeds the two components to a static mixer in the desired ratio. As the components flow through the mix-head intimate mixing occurs and the resin composition is then ready for supply to a mould for infusion with fibre to produce a composite part. An ATR (attenuated total reflectance) probe was inserted into the path of the flowing resin after the static mixer and the signal from the probe transferred to a Fourrier transform infrared (FTIR) analyser by a fibre optic. The analyser and software record and interpret the spectra to give a ratio of amine to epoxy content of the mixture which can be determined from the relative area under the FTIR peaks associated with epoxide and amine function groups. The nominal correct ratio of epoxy to amine was selected to be 100 parts resin to 68.1 parts of amine. For simplicity the mix ratio is defined as the parts amine per 100 epoxy, in this case 68.1 by weight or 79.5 by volume.

The infrared spectral plot of such a mixture is shown in FIG. 3.

In order to illustrate the invention the ratio of amine to epoxy based components in the resin composition was varied, and the plot of mix ratio (% change from nominal of 68.1) calculated by the FTIR software, showing the change from nominal ratio as the resin composition is mixed at different ratios of the components, is shown in FIG. 4.

To maintain robust performance of the invention, it is necessary to maintain the mix ratio with ±3% of nominal. These data show that the in-line FTIR probe and analyser can accurately track changes to ±1% of nominal.

### EXAMPLE 2

A calibration model was built by carrying out NIR spectroscopic analysis of a curable epoxy resin based system containing various known concentrations of amine curative. The epoxy resin was based on HexFlow® RTM6, available from Hexcel Corporation, USA, but with the concentration of the curative altered by a known amount in some cases. The testing was carried out by passing the resin compositions through a 12 mm diameter glass tube that was 100 or 130 mm in length, with a wall thickness of 2.2 mm. The glass tube was then inserted into a suitable holder and then attached to a Clippir wet process analyser accessory (ACC127, available from ABB, USA) comprising an FT-NIR spectrometer probe. The spectrometer probe was connected to an FT-NIR single channel process analyser (TALYS ASP501, available from ABB, USA).

Once the calibration model had been built a batch of HexFlow® RTM6 resin having a standard (nominal) concentration of curative was tested in 3 runs for up to 800 seconds. The measured deviation in the concentration of the curative compared to the nominal value in each run is shown in FIG. 5.

As shown in FIG. 5, the test method according to the present invention was able to measure the concentration of the curative with an accuracy of no more than plus or minus 0.5% of the actual value.

### EXAMPLE 3

The method of Example 2 was repeated using resins that were not used to construct the model in Example 2. A first batch of HexFlow® RTM6 having an adjusted concentration of curative of plus 2% of the normal value, and a second batch having an adjusted concentration of curative of minus 2% of the normal value were tested, as set out in Example 2. The results are shown in FIG. 6.

As shown in FIG. 6, the test method according to the present invention was able to accurately detect changes in the curative concentration of plus or minus 2% of the nominal concentration.

1. A process for infusing resin into a fibrous reinforcement, comprising: infusing a curable flowing fluid resin composition into a fibrous reinforcement material, wherein the curable flowing fluid resin composition comprises a resin component and an activator component, and at least one property of the curable flowing fluid resin composition is monitored prior to infusion.

2. The resin infusion process according to claim 1, further comprising: a feedback loop whereby the monitoring is used to control the composition of the curable flowing fluid resin composition.

3. (canceled)

4. (canceled)

5. (canceled)

6. (canceled)

7. The resin infusion process according to claim 2, in which the curable flowing fluid composition and/or the resin component is liquid.

8. The resin infusion process according to claim 7, in which the property that is monitored is the viscosity of the curable flowing fluid resin composition.

9. The resin infusion process according to claim 7, in which the property that is monitored is the T_{g} of the curable flowing fluid resin composition.

10. The resin infusion process according to claim 7, wherein at least one property of the curable flowing fluid resin composition is monitored at regular time intervals.

11. The resin infusion process according to claim 7, wherein the activator component of the curable flowing fluid resin composition is an amine based reactive compound and the resin component of the curable flowing fluid resin composition comprises an epoxy resin component.

12. The resin infusion process according to claim 11, wherein the ratio of amine to epoxy groups in the curable flowing fluid resin composition is monitored.

13. (canceled)

14. The resin infusion process according to claim 12, in which the property that is monitored is the chemical composition or stoichiometry of the curable flowing fluid resin composition.

15. The resin infusion process according to claim 14, wherein the chemical composition or stoichiometry of the curable flowing fluid resin composition is monitored by a near infrared spectrometer.

16. (canceled)

17. The resin infusion process according to claim 15, wherein the spectrometer is an FTIR or FT-NIR spectrometer.

18. The resin infusion process according to claim 17, wherein the chemical composition or stoichiometry of the curable flowing fluid resin composition is monitored as the curable flowing fluid resin composition passes through a measurement component.

19. The resin infusion process according to claim 18, wherein the measurement component comprises a conduit.

20. The resin infusion process according to claim 19, wherein the spectrometer is located outside the measurement component so that the curable flowing fluid resin composition does not contact any part of the spectrometer.

21. The resin infusion process according to claim 20, wherein the walls of the measurement component do not absorb in the regions used for the spectroscopic monitoring.

22. The resin infusion process according to claim 21, wherein the measurement component is at least partially formed from silicone, a perfluoroalkoxy material or glass.

23. The resin infusion process according to claim 22, wherein the internal diameter of the measurement component is selected to not interfere with the spectroscopic monitoring.
